(19) United States
(12) Patent Application Publication
(10) Pub. No.: US 2024/0317937 A1
(43) Pub. Date: Sep. 26, 2024

(54) FLAME RETARDANT POLYAMIDE COMPOSITIONS

(71) Applicant: INV NYLON POLYMERS AMERICAS, LLC, Wilmington, DE (US)

(72) Inventors: Alexander L. Gulledge, Columbia, SC (US); Isaac K. Iverson, Wichita, KS (US); Chee Sern Lim, Kennesaw, GA (US); Charles Richard Langrick, Middlesbrough (GB); Deborah M. Sarzotti, Kingston (CA)

(21) Appl. No.: 18/578,737

(22) PCT Filed: Jun. 23, 2022
(86) PCT No.: PCT/GB2022/051604

§ 371 Date: Jan. 12, 2024

Related U.S. Application Data
(60) Provisional application No. 63/227,589, filed on Jul. 30, 2021.

(51) Int. Cl. C08G 69/26; C08G 69/28; C08K 5/00

(52) U.S. Cl. CPC C08G 69/265; C08G 69/28; C08K 5/0066

(57) ABSTRACT

The present invention relates to a composition of matter comprising: a) random copolymer of: i) a first straight-chain aliphatic condensation polyamide; and ii) a second condensation polyamide comprising a branched diamine and an aromatic diacid, wherein the mass ratio of the first straight-chain aliphatic condensation polyamide to the second condensation polyamide is from ≥85:15 to ≤99:1; and b) from ≥5 wt % to ≤25 wt % of non-halogenated flame retardant additive; wherein the flame-retardancy (FR) performance, as measured by flammability measurement according to the Underwriters Laboratories standard (UL 94) for Vertical Burn test, of the composition exceeds the FR performance of a control consisting essentially of nylon-6,6 characterized by formic acid relative viscosity (RV) within ±3 and amine end groups (AEG) within ±5 of the random copolymer (a), and wherein the composition of matter contains from ≥50% to ≤80% of the non-halogenated flame retardant (FR) additive compared to the control.

### FIELD

The disclosure herein relates to modified nylon polymer resins for use in articles and molded parts.

### BACKGROUND

The homopolymer, polyhexamethylene adipamide (commonly known in the art as PA66 or N66), can crystallize very rapidly when cooled from a melt state. The N66 crystallization rate is known to be strongly temperature dependent and reaches a maximum rate at about 220° C. At this temperature, the kinetic half time (t_{1/2}) of crystallization is about one minute. For some polymer applications, this can be a disadvantage, such as for surface appearance and dimensional stability of molded parts from glass fiber (i.e., GF) reinforced resins. Copolymers based on N66 may give better results if crystallization rate is slowed sufficiently.

An aliphatic nylon copolyamide comprising 60-99.5 mole % hexamethylene adipamide units and 0.5-40 mole % 2-methyl-pentamethylene adipamide units is described in U.S. Pat. No. 5,194,578. This disclosure relates to fibers and textile applications of the copolyamide.

U.S. Pat. No. 10,711,104 B2 relates to a composition comprising from about 65 to about 95 wt. % of an aliphatic polyamide and a copolyamide containing about 40 to about 60 mol % 2-methyl-1,5-pentamethyleneterephthalamide (“MPMD-T”) units and about 40 to about 60 mol % 2-methyl-1,5-pentamethyleneisophthalamide (“MPMD-I”) units.

### SUMMARY

Disclosed are compositions exhibiting improved sensitivity to halogen-free phosphorus-containing flame retardant (FR) additives. As will be understood by the skilled person, improved sensitivity to halogen-free phosphorus containing FR additives means that less halogen-free phosphorus containing FR additives are required in a composition to achieve the same flame retardancy performance. Accordingly, the resulting compositions have improved sustainability as less material is used. In addition, given that the halogen-free phosphorus containing FR additives typically used in the art are expensive, the resulting compositions comprising less halogen-free phosphorus containing are more economical.

The present invention relates to a composition of matter comprising:
a) random copolymer of:
   i) a first straight-chain aliphatic condensation polyamide; and
   ii) a second condensation polyamide comprising a branched diamine and an aromatic diacid,
      wherein the mass ratio of first straight-chain aliphatic condensation polyamide to second condensation polyamide is from ≥85:15 to ≤99:1; and
b) from ≥5 wt % to ≤25 wt % of non-halogenated flame retardant additive;
   wherein the flame-retardancy (FR) performance, as measured by flammability measurement according to the Underwriters Laboratories standard (UL 94) for Vertical Burn test, of the composition exceeds the FR performance of a control consisting essentially of nylon-6,6 characterized by formic acid relative viscosity (RV) within ±3 and amine end group (AEG)±5 of the random copolymer (a), and wherein the composition of matter contains from ≥50% to ≤80% of the non-halogenated flame retardant (FR) additive compared to the control.

As used herein, “consists essentially of” or “consisting essentially of” means that specific further components can be present provided that they do not materially affect the essential characteristics of the composition. Accordingly, where a control consists essentially of nylon-6,6 this means that the control does not include any other components that materially affect the essential characteristics of the control. In particular, where a control consists essentially of nylon-6,6 it does not include any other polyamides or any other diamine or diacid monomers.

As will be understood, the control described herein is identical to the composition of matter with the exception of the polyamide identity and amount of FR additive present.

The present invention also relates to use of a random copolymer for the purpose of providing a composition of matter comprising said random copolymer with similar or improved flame-retardancy (FR) performance compared to a control, wherein the flame-retardancy (FR) performance is measured by flammability measurement according to the Underwriters Laboratories standard (UL 94) for Vertical Burn test; wherein said composition of matter comprises:
a) said random copolymer of:
   i) a first straight-chain aliphatic condensation polyamide; and
   ii) a second condensation polyamide comprising a branched diamine and an aromatic diacid,
      wherein the mass ratio of the first straight-chain aliphatic condensation polyamide to the second condensation polyamide is from ≥85:15 to ≤99:1; and
b) from ≥5 wt % to ≤25 wt % of non-halogenated flame retardant additive;
   wherein said control consists essentially of nylon-6,6 characterized by formic acid relative viscosity (RV) within ±3 and amine end groups (AEG) within ±5 of said random copolymer (a); and
   wherein said composition of matter contains from ≥50% to ≤80% of the non-halogenated flame retardant (FR) additive compared to said control.

As used herein, the terms “non-halogenated” and “halogen-free” are used interchangeably to refer to a flame-retardant additive that does not contain any carbon-halogen bonds.

Preferably, the halogen-free flame-retardant (FR) additive is a halogen-free phosphorus-containing FR additive. Accordingly, it is preferred that the composition according to the present invention can contain from ≥50% to ≤80% by weight of the halogen-free phosphorus-containing FR additive compared to the control.

Advantageously, the composition according to the present invention can contain from ≥50% to ≤80% by weight of the FR additive compared to the control without compromising any FR performance (as measured by flammability measurement according to the Underwriters Laboratories standard (UL 94) for Vertical Burn test).

Furthermore, the composition according to the present invention can advantageously contain from ≥50% to ≤80% by weight of the FR additive compared to the control without compromising any mechanical strength (e.g., yield stress, tensile strength, elongation at break, Chord modulus, notched Charpy and/or un-notched Chary). In fact, the composition according to the present invention provides flame retardant specimens having improved mechanical strength compared with control flame retardant specimens consisting essentially of nylon-6,6, wherein the composition contains from ≥50% to ≤80% of the non-halogenated flame retardant (FR) additive compared to the control composition.

Preferably, the mass ratio of the first straight-chain aliphatic condensation polyamide to the second condensation polyamide is from ≥90:10 to ≤97:3.

Suitable first straight-chain aliphatic condensation polyamides comprise at least one of PA 46, PA 66; PA 69; PA 610, PA 612, PA 1012, PA 1212, PA 66/6T, PA 6I/6T, PA 66/6I/6T or blends, such as PA6/PA66, polyhexamethylene decanamide (N610), polyhexamethylene dodecanamide (N612), polyhexamethylene succinamide (N46), polyhexamethylene azelamide (N69), polydecamethylene sebacamide (N1010), polydodecamethylene dodecanamide (N1212), nylon 6 (N6), nylon 11 (N11), polylaurolactam (N12). Preferably, the first straight-chain condensation polyamide in the composition according to the present invention is PA 66.

The branched diamine can be a C₄ to C₁₂ diamine.

For example, the branched diamine can be at least one of 1,3-pentanediamine, 2-ethyl-butanediamine, 2-methylpentamethylene diamine, 3-methylpentamethylene diamine, 2-methylhexamethylene diamine, 3-methylhexamethylene diamine, 2,5-dimethylhexamethylene diamine, 2,2,4-trimethylhexamethylene diamine, 2,4,4-trimethylhexamethylene diamine, 2,7-dimethyloctamethylene diamine and 2,2,7,7-tetramethyloctamethylene diamine. Preferably, the branched diamine in the composition according to the invention is 2-methylpentamethylene diamine, which is also referred to as MPMD.

Suitable aromatic diacids include C₅ to C₁₂ diacids containing from ≥1 to ≤3 aromatic rings per monomer unit.

Suitable aromatic diacids further include at least one diacid of the formula HO—C(O)—R¹—C(O)—OH, wherein the variable R¹ is substituted or unsubstituted furan, benzofuranyl, phenyl, naphthyl, anthracenyl.

Preferably, the aromatic diacid can comprise one or more of terephthalic acid and isophthalic acid. More preferably, the aromatic diacid comprises isophthalic acid.

Preferably, the composition according to the present invention comprises a random copolymer consisting of, or consisting essentially of, n-6,6/DI having weight ratio of n-6,6 to (D+I) of from ≥85:15 to ≤99:1. More preferably, the composition according to the present invention comprises a random copolymer consisting of, or consisting essentially of, n-6,6/DI having weight ratio of n-6,6 to (D+I) of from ≥90:10 to ≤97:3.

Disclosed compositions include non-halogenated flame retardant additives, for example, those that contain neither carbon-iodine, carbon-bromine, nor carbon-chlorine bonds. The disclosed composition can comprise a non-halogenated flame retardant additive singularly or in combination with phosphorus based FR additives including organophosphorus based acids such as diarylphosphinic, diarylphosphonic, dialkylphosphinic or dialkylphosphonic acids, and their salts (including metal salts and organic salts), dihydrooxaphosphaphenanthrene (DOPO) and its derivatives, polyphosphazenes; organo-nitrogen based FR additives including melamine and its salts; boron based FR additives including metal borates; and silicon based FR additives such as silicones. Preferably, the non-halogenated flame retardant additive is a non-halogenated phosphorus-containing (i.e., phosphorus based) flame-retardant additive.

The non-halogenated flame retardant additive can be selected from melamine cyanurate, aluminium diethylphosphinate, melamine polyphosphate, antimony trioxide, dehydrated zinc borate and combinations thereof.

Non-limiting examples of various commercially available flame retardant additives may include, BASF Melapur™ MC25 halogen-free flame retardant or BASF Irganox® B1171 polymer additive product; Mastertek® antimony trioxide concentrate masterbatches from Campine NV; Clariant Exolit® OP1314 or OP1400 non-halogenated organic phosphinate flame retardant; Presafer (Quingyuan) Phosphor Chemical Co. Ltd. Preniphor™ EPFR-MPP300 halogen-free, melamine polyphosphate flame retardant; Albemarle SAYTEX® HP 7010 bromine-based flame retardant; Campine PA 261717 50% masterbatch of antimony trioxide [CAS No 1309-64-4] in Nylon 6; Borax Europe Ltd Firebrake® 500 dehydrated zinc borate based fire retardant, or combinations thereof.

Further disclosed is a composition of matter comprising:
a) a random copolymer of:
   (1) a first aliphatic condensation polyamide containing less than 0.1 wt. % of monomers selected from branched diamines and aromatic diacids;
   (2) a second condensation polyamide comprising a branched diamine and an aromatic diacid; and
b) a halogen-free phosphorus-containing flame retardant additive wherein:
   i) the weight ratio of the first aliphatic condensation polyamide (1) to the second condensation polyamide (2) is from ≥90:10 to ≤94:6; and
   ii) the flame-retardancy (FR) performance of the random copolymer as measured by UL 94 Vertical Burn testing exceeds the performance (as measured by the same UL 94 Vertical Burn testing) of a control comprising:
      (1) the first aliphatic condensation polyamide;
      (2) from ≥0 to ≤0.1 wt. % of the second condensation polyamide; and
      (3) the same (±0.5% based on weight of additive) amount of halogen-free phosphorus-containing flame retardant additive, wherein said first aliphatic condensation polyamide of (ii)(1) and the random copolymer of (a) are both characterized by the same formic acid relative viscosity (RV; i.e., within ±3 of each other) and the same amine end group (AEG; i.e., within ±5 of each other), and wherein the composition of matter contains from ≥50% to ≤80% of the halogen-free phosphorus-containing FR additive compared to the control.

For the composition described immediately above, the composition according to the invention and the control can both further comprise from ≥5 wt. % to ≤25 wt. % of halogen-free phosphorus-containing flame retardant additive.

Advantageously, the compositions of the present invention have improved FR additive sensitivity whilst containing from ≥50% to ≤80% by weight of the halogen-free phosphorus-containing FR additive as the control.

Preferably, the first straight-chain aliphatic condensation polyamide comprises an aliphatic diamine.

The branched diamine can be a C₄ to C₂₀ diamine characterized by carbon branching ratio (as defined herein) selected from the group consisting of:
a) ≥0 to ≤1;
b) ≥0.2 to ≤0.8; and
c) ≥0.25 to ≤0.75.

For embodiments in which particular FR sensitivity can be observed, the branched diamine can be at least one of ESN (i.e., 2-ethylsuccinonitrile) and MPMD (i.e., 2-methylpentamethylene diamine).

Disclosed compositions can include aromatic diacid such as a C₄ to C₁₂ diacid containing from ≥1 to ≤3 aromatic rings per monomer unit, for example, an aromatic diacid comprises at least one diacid of the formula HO—C(O)—R¹—C(O)—OH, wherein the variable R¹ is substituted or unsubstituted furan, benzofuranyl, phenyl, naphthyl, anthracenyl. The aromatic diacid can comprise at least one selected from terephthalic acid and isophthalic acid.

Further disclosed are compositions of matter comprising:
a) random copolymer of n-6,6/DI having weight ratio of n-6,6 to DI of from ≥85:15 to ≤99:1; and
b) from ≥5 wt. % to ≤25 wt. % of halogen-free phosphorus-containing flame retardant additive;
   i) wherein the FR performance of the composition comprising (a) and (b) as measured by UL 94 Vertical Burn testing exceeds the performance (as measured by the same UL 94 Vertical Burn testing) of a control comprising:
      (i) nylon-6,6 containing ≤0.1 wt. % of DI, said nylon-6,6 characterized by formic acid RV within ±3 and AEG within ±5 of random copolymer (a); and
      (ii) from ≥5 wt. % to ≤25 wt. % of halogen-free phosphorus-containing flame retardant additive,
         wherein the composition of matter comprising (a) and (b) contains from ≥50% to ≤80% of the halogen-free phosphorus-containing flame retardant additive compared to the control.

### DETAILED DESCRIPTION

The terms “nylon-6”, “Polyamide 6”, “PA6”, “N6” are used interchangeably and refer to polycaproamide, which is a homo-polyamide formed from caprolactam.

The terms “nylon-6,6”, “Polyamide 66”, “PA66”, “N66”, “nylon 6-6”, “n-6,6” or “nylon 6/6” are used interchangeably and refer to polyhexamethylene adipamide, which is a polyamide formed by polycondensation reaction between hexamethylene diamine (HMD) and adipic acid (AA).

As used herein, “PA66 (20-36 RV)” refers to a polyhexamethylene adipamide having a relative viscosity (RV) of from 20 to 36. Such polyamides are described in International Patent Publication No. WO2019/125379A1 and commercially available under the trademark of HYPERFLOW™ Polyamide from INVISTA Intermediates.

As used herein, “PA66/DI” refers to a type of copolyamide formed by combining a N66 salt solution with a DI salt solution, where “D” is an abbreviation for 2-methyl-1,5-pentamethylene diamine (also known as MPMD), and “I” is an abbreviation for isophthalic acid that is commercially available. MPIMD is commercially available under a registered trademark to INVISTA S. á r. l. as DYTEK® A Amine (CAS Registry Number 15520-10-2). PA66/DI may contain about 80-99% PA66 and about 1-20% DI on the mass basis, for example, about (on wt:wt basis) 99:1 or 97:3 or 95:5 or 92:8 or 90:10 or 85:15 or 80:20 for PA66:DI achieved for the salts on dry basis. The “DI” part in PA66/DI is about 50:50 (molar) or about 40:60 D:I (mass ratio). PA66/DI is known as a copolymer of hexamethylene adipamide and 2-methyl-1,5-pentamethylene-isophthalamide. PA66/DI used in the examples has a relative viscosity (RV) of 45. However, the RV range for PA66/DI can be between 35 and 60 and may contain amine end groups (AEG) between 40 to 80 meg/kg, for example, between 60 to 80 meg/kg, or 65 meg/kg, or 70 meg/kg. Standard batch evaporation and batch autoclave polymerization processes are used to produce the copolymer. These methods are polymerization processes generally known to the skilled person.

As used herein, “PA66/D6” refers to a type of copolyamide formed by combining a PA66 salt solution with a D6 salt solution (where “D” is an abbreviation for 2-methyl-1,5-pentamethylene diamine (MPMD) and “6” refers to adipic acid, a C₆ dicarboxylic acid), and having about (on wt:wt basis) 90/10 or 87/13 or 85/15 or 82/18 or 80/20 or 75/25 or 70/30 for PA66/D6 achieved for the salts on dry basis. Standard batch evaporation and batch autoclave polymerization processes are used to produce the copolymer. The diacid equivalent is adipic acid, abbreviated as “6” and used with the same diamine “D” described above. This copolyamide resin has a calculated formic acid solution RV of 45, 0.144 wt. % moisture and a maximum crystallization rate at about 150° C. Disclosed is a copolyamide N66/D6 (70/30) made by combining PA66 salt solution with D6 salt solution and using a 70/30 mass ratio for the salts on dry basis. Standard batch evaporation and batch autoclave polymerization processes are used to produce the copolymer. The diacid equivalent is adipic acid, a six-carbon dicarboxylic acid.

The present invention advantageously provides a modified nylon comprising, consisting of, or consisting essentially of, random copolymers of N66/DI with D substitution for HMD at 5 to 15 mol % and isophthalic acid (I) substitution for adipic acid at 5 mole % to 15 mole % and having slower crystallization rates than N66 homopolymer, which can further advantageously provide improved surface appearance and gloss in extruded and molded parts.

The term “carbon branching ratio”, used in the present disclosure, describes the extent to which aliphatic carbons are present in branches versus in the backbone chain of the molecular. For example, isobutane has one carbon in a branch and three in the backbone chain, for a carbon branching ratio of 1:3 (i.e. 0.33). MPMD contains six (6) carbon atoms, of which one is present in a branch, for a carbon branching ratio of 1:5 (i.e., 0.2). 2-ethyl-butanediamine contains six (6) carbon atoms, of which two are present in a branch, for a carbon branching ratio of 2:4 (i.e., 0.5). 1,6-hexamethylene diamine (HMD) contains six (6) carbon atoms, of which none is present in a branch, for a carbon branching ratio of 0:6 (i.e., 0). As will be understood by the skilled person, the branching ratio of a straight-chain aliphatic is always zero.

Polyamides can be manufactured by polymerization of dicarboxylic acids and diacid derivatives and diamines. In some cases, polyamides may be produced via polymerization of aminocarboxylic acids, aminonitriles, or lactams. The dicarboxylic acid component is suitably at least one dicarboxylic acid of the molecular formula HO₂C—R¹—CO₂H; wherein R¹ represents a divalent aliphatic, cycloaliphatic or aromatic radical or a covalent bond. R¹ suitably includes from 2 to 20 carbon atoms, for example 2 to 12 carbon atoms, for example 2 to 10 carbon atoms. For example, R¹ is an alkylene radical, for example an alkylene radical, including 2 to 12 carbon atoms, or 2 to 10 carbon atoms, for example 2, 4, 6 or 8 carbon atoms. R¹ may be a linear or branched, for example linear, alkylene radical including 2 to 12 carbon atoms, or 2 to 10 carbon atoms, for example 2, 4, 6 or 8 carbon atoms, an unsubstituted phenylene radical, or an unsubstituted cyclohexylene radical. Optionally, R¹ may contain one or more ether groups.

Specific examples of suitable dicarboxylic acids include hexane-1,6-dioic acid (adipic acid), octane-1,8-dioic acid (suberic acid), decane-1,10-dioic acid (sebacic acid), dodecane-1,12-dioic acid, 1,2-cyclohexanedicarboxylic acid, 1,3-cyclohexanedicarboxylic acid, 1,4-cyclohexanedicarboxylic acid, 1,2-cyclohexanediacetic acid, 1,3-cyclohexanediacetic acid, benzene-1,2-dicarboxylic acid (phthalic acid), benzene-1,3-dicarboxylic acid (isophthalic acid), benzene-1,4-dicarboxylic acid (terephthalic acid), 4,4′-oxybis(benzoic acid), and 2,6-naphthalene dicarboxylic acid. A suitable dicarboxylic acid is hexane-1,6-dioic acid (adipic acid).

The diamine component is suitably at least one diamine of the formula H₂N—R²—NH₂; wherein R² represents a divalent aliphatic, cycloaliphatic or aromatic radical. R² suitably includes from 2 to 20 carbon atoms, for example 4 to 12 carbon atoms, for example 4 to 10 carbon atoms. For example, R² is an alkylene radical, for example an alkylene radical, including 4 to 12 carbon atoms, or 4 to 10 carbon atoms, for example 2, 4, 6 or 8 carbon atoms. R² may be a linear or branched, for example linear, alkylene radical including 4 to 12 carbon atoms, for example 4 to 10 carbon atoms, for example 4, 6 or 8 carbon atoms, an unsubstituted phenylene radical, or an unsubstituted cyclohexylene radical. Optionally, R² may contain one or more ether groups.

Specific examples of suitable diamines include tetramethylene diamine, pentamethylene diamine, hexamethylene diamine, octamethylene diamine, decamethylene diamine, dodecamethylene diamine, 1,3-pentanediamine, 2-ethyl-butanediamine, 2-methylpentamethylene diamine, 3-methylpentamethylene diamine, 2-methylhexamethylene diamine, 3-methylhexamethylene diamine, 2,5-dimethylhexamethylene diamine, 2,2,4-trimethylhexamethylene diamine, 2,4,4-trimethylhexamethylene diamine, 2,7-dimethyloctamethylene diamine, 2,2,7,7-tetramethyloctamethylene diamine, 1,2-cyclohexanediamine, 1,3-cyclohexanediamine, 1,4-cyclohexanediamine, 4,4′-diaminodicyclohexylmethane, benzene-1,2-diamine, benzene-1,3-diamine and benzene-1,4-diamine. A suitable diamine is hexamethylene diamine.

The aromatic diacid is suitably at least one diacid of the formula HO—C(O)—R³—C(O)—OH, wherein the variable R³ is substituted or unsubstituted aryl, such as phenyl. In one aspect, the aromatic diacid is terephthalic acid. In another aspect, the aromatic diacid is isophthalic acid.

The branched diamine is suitably selected from 1,3-pentanediamine, 2-ethyl-butanediamine, 2-methylpentamethylene diamine, 3-methylpentamethylene diamine, 2-methylhexamethylene diamine, 3-methylhexamethylene diamine, 2,5-dimethylhexamethylene diamine, 2,2,4-trimethylhexamethylene diamine, 2,4,4-trimethylhexamethylene diamine, 2,7-dimethyloctamethylene diamine and 2,2,7,7-tetramethyloctamethylene diamine. Preferably, the branched diamine is 2-methylpentamethylene diamine.

The polyamide resin can further include a catalyst. In one aspect, the catalyst can be present in the polyamide resin in an amount ranging from 10 ppm to 1,000 ppm by weight. In another aspect, the catalyst can be present in an amount ranging from 10 ppm to 300 ppm by weight. The catalyst can include, without limitation, phosphorus and oxyphosphorus compounds, such as, phosphoric acid, phosphorous acid, hypophosphorous acid, hypophosphoric acid, arylphosphonic acids, arylphosphinic acids, salts thereof, and mixtures thereof. In one aspect, the catalyst can be sodium hypophosphite (SHP), manganese hypophosphite, sodium phenylphosphinate, sodium phenylphosphonate, potassium phenylphosphinate, potassium phenylphosphonate, hexamethylenediammonium bis-phenylphosphinate, potassium tolylphosphinate, or mixtures thereof. In one aspect, the catalyst can be sodium hypophosphite (SHP).

The polyamide described herein can terminate in any suitable way. In some aspects, the polyamide can terminate with an end group that is independently chosen from a suitable polymerization initiator, —H, —OH, —CO₂H, —NH₂, CO₂⁻, —NH₃⁺, a substituted or unsubstituted (C₁-C₂₀) hydrocarbyl (e.g., (C₁-C₁₀) alkyl or (C₆-C₂₀) aryl) interrupted with 0, 1, 2, or 3 groups independently selected from —O—, substituted or unsubstituted —NH—, and —S—, a poly(substituted or unsubstituted (C₁-C₂₀) hydrocarbyloxy), and a poly(substituted or unsubstituted (C₁-C₂₀) hydrocarbylamino). In a preferred embodiment the polyamide is terminated by a combination composing of carboxylic acid (—CO₂H, —CO₂⁻), amine (—NH₂, —NH₃⁺) and acetyl (—CO₂Me) end groups.

Preferably, the compositions of the invention comprise a random copolymer as defined herein having a relative viscosity (RV) as measured in 8.4 wt. % solution in 90% formic acid of from 20 to 60 RV, preferably of from 22 to 45 or 35 to 50 RV.

Preferably, the compositions of the invention comprise a random copolymer as defined herein having amine end groups (AEG) of between 40 to 90 meg/kg, preferably between 60 to 80 meg/kg.

Preferably, the composition according to the present invention can optionally comprise acetic acid. Preferably, the random copolymer according to the present invention can optionally comprise acetic acid. More preferably, the random copolymer according to the present invention (which can suitably be considered as a modified nylon polymer) may comprise acetic acid in an amount of about 1 to about 10,000 parts per million by weight (ppmw) of the copolymer.

Preferably, the composition of the present invention comprises one or more fibers. Non-limiting examples of fibers may include carbon fiber, carbon nano-fiber, glass fiber, basalt fiber, natural fiber, mineral fiber, nano-cellulosic fiber, wood fibers, non-wood plant fibers, or combinations thereof. Non-limiting examples of fillers may include talc, mica, clay, silica, alumina, carbon black, wood flour, sawdust, wood shavings, newsprint, paper, flax, hemp, wheat straw, rice hulls, kenaf, jute, sisal, peanut shells, soy hulls, or combinations thereof. Preferably, the compositions of the present invention comprise one or more glass fibers.

In various preferred aspects, the present disclosure provides a glass fiber-filled polyamide composition. The glass fiber-filled polyamide composition preferably includes ≥10 to ≤60 wt. % glass fibers blended with the polyamide, based on the weight of the polyamide including the glass fibers. The disclosed compositions can preferably contain from ≥10 wt. % to ≤60 wt. % glass fibers, for example, ≥15 wt. % to ≤55 wt. % glass fibers, ≥20 wt. % to ≤40 wt. % glass fibers, for example 25 wt. % or 30 wt. % or 35 wt. % or 40 wt. % or 45 wt. % or 50 wt. % glass fibers, based on the weight of the finished polyamide composition including all additives and fillers (including the glass fibers).

In the present disclosure, the term “glass fiber” is abbreviated as “GF” which is understood to be a standard nomenclature in the polymer and compounding industry. The amount of GF in the polymer sample is represented as wt. % of the total, unless stated otherwise.

Disclosed compositions include those in which the monomers comprise hexamethylenediamine and adipic acid. For instance, the disclosed polyamide can include a polyamide PA 46, PA 66; PA 69; PA 610, PA 612, PA 1012, PA 1212, PA 6, PA 11, PA 12, PA 66/6T, PA 6I/6T, PA 66/6I/6T or blends, such as PA6/PA66. The naming convention is well known in the art, for example, polycaproamide (N6), polyhexamethylene decanamide (N610), polyhexamethylene dodecanamide (N612), polyhexamethylene succinamide (N46), polyhexamethylene azelamide (N69), polydecamethylene sebacamide (N1010), polydodecamethylene dodecanamide (N1212), nylon 11 (N11), polylaurolactam (N12), nylon 6T/DT.

Suitable aliphatic condensation polyamides for inclusion in the disclosed compositions include those with carbon branching ratios from 0 to 1, for example from 0.2 to 0.8, for example, from 0.25 to 0.75.

The composition of the present disclosure can optionally include conventional plastics additives in an amount that is sufficient to obtain a desired processing or performance property for the compound. The amount should not be wasteful of the additive nor detrimental to the processing or performance of the composition. Those skilled in the art of thermoplastics compounding, without undue experimentation but with reference to such treatises as Plastics Additives Database (2004) from Plastics Design Library (elsevier.com website), can select from many different types of additives for inclusion into the compositions of the present disclosure.

Non-limiting examples of optional additives include adhesion promoters, biocides, anti-fogging agents, anti-static agents, anti-oxidants, bonding, blowing and foaming agents, catalysts, dispersants, extenders, smoke suppressants, impact modifiers, initiators, lubricants, nucleants, pigments, colorants and dyes, optical brighteners, plasticizers, processing aids, release agents, silanes, titanates and zirconates, slip agents, anti-blocking agents, stabilizers, stearates, ultraviolet light absorbers, waxes, catalyst deactivators, and combinations thereof.

### PA66/DI and PA66/D6 Preparations:

According to the conventional batch autoclave method employed herein, a 40-60% polyamide salt solution formed from equimolar amounts of diacid and diamine in water, is charged into a pre-evaporator vessel operated at a temperature of about 130-160° C. and a pressure of about 180 to about 690 kPa absolute, wherein the polyamide salt solution is concentrated to about 70-80%. This concentrated solution is transferred to the autoclave, where heating is continued as the pressure in the vessel rises to about 1100 to about 4000 kPa absolute. Steam is vented until the batch temperature reaches about 220-260° C. The pressure is then reduced slowly (over about 30-90 minutes) to about 100 kPa absolute or lower. The polymer molecular weight is controlled by the hold time and pressure at this stage. Salt concentration, pressure, and temperature may vary depending on the specific polyamide being processed. After the desired hold time, the polyamide is then extruded into strand, cooled, and cut into pellets (also known as granulates).

In this batch process, a phosphorus compound or other additive may be introduced before polymerization (i.e. into a solution of at least one polyamide-forming reactant), or can be introduced at any point during polymerization, or can even be introduced post-polymerization (i.e. by incorporating the phosphorus compound and the base into a polyamide melt, using conventional mixing equipment, such as an extruder). The phosphorus compounds and additives can be introduced separately or all at once. As a means for protection against oxidation and thermal degradation, the phosphorus compound and additives are provided early in the polymerization process, such as at the beginning of the polymerization process. Additives which may be in solid form can be provided as solids or in the form of aqueous solutions.

It may also be feasible to use a pre-made amine mixture of INVISTA S. à r. 1. DYTEK® A Amine (CAS Registry Number 15520-10-2) and HMD. The individual component strengths in such mixture may depend on the final n-66/DI wt/wt compositions of interest. Non-limiting examples of such amine mixtures may include INVISTA DYTEK® A Amine: HMD blends (wt: wt) of 10:90, 20:80, 25:75, 30:70, 35:65, 40:60, 45:55, 50:50, 55:45, 60:40, 65:35, 70:30, 75:25, 80:20, 90:10 and such.

INVISTA Dytek® A amine is commercially produced by hydrogenating 2-methylglutaronitrile (or “MGN”). MGN is a branched C6 dinitrile obtained as a side-product from butadiene double-hydrocyanation process of adiponitrile [or ‘ADN”] manufacture. The otherwise disposed MGN side-product can be recycled and reused in the production of INVISTA Dytek® A amine or the “D” portion; the PA66/DI produced by this process, therefore, is considered to have the recycled amine content coming from the “D” portion.

In one embodiment of the present disclosure, the composition may comprise one or more C₄-C₁₂ branched dinitrile that is recovered from a manufacturing process, converted to corresponding C₄-C₁₂ branched diamine and incorporated into polymer as an alternative to burning the branched dinitrile as fuel. In non-limiting examples, the C₄-C₁₂ branched dinitrile comprises 2-ethylsuccinonitrile and 2-methylglutaronitrile.

There are a variety of tests and standards that may be used to rate the flame retardant nature of a polymeric resin system. Underwriters' Laboratories Test No. UL-94 serves as one Industry Standard test for flame retardant thermoplastic compounds. “UL-94 Standard for Tests for Flammability of Plastic Materials for Parts in Devices and Appliances” gives details of the testing method and criteria for rating. The test method ASTM D635 is Standard Test Method for Rate of Burning and/or Extent and Time of Burning of Plastics in a Horizontal Position. The test method ASTM D3801 is Standard Test Method for Measuring the Comparative Burning Characteristics of Solid Plastics in a Vertical Position. Unless stated otherwise, flame-retardancy (FR) performance is measured herein in accordance with the UL-94 vertical flame test.

Other tests and instruments exist to rate flammability, such as but not limited to, the Limiting Oxygen Index (LOI) test (ASTM 2863); the cone calorimetry instrument, which measures amount and rate of heat release during combustion (ASTM E 1354 and ISO 5660-1 standards are both based upon this instrument); Glow Wire Flammability test (IEC 60695-2-12); and Glow Wire Ignition test (IEC 60695-2-13).

Other tests which exist to rate flame retardancy include, and are not limited to, those where the rate of smoke generation, smoke obscuration, the toxicity of smoke and combustion gases, are determined. Other tests exist to rate flame retardancy which are application specific, these include but are not limited to applications such as; apparel fabrics, upholstery fabrics, airbag fabrics, carpets, rugs.

### Test Methods

As used herein the following terms and test procedures are defined as follows:

ASTM D789-19—formic acid solution relative viscosity.

ISO 1183-1:2019—density of the sample.

ISO 527-1:2019—tensile properties including tensile modulus (MPa) testing of molded and extruded plastics,% elongation-at-break testing of materials, tensile strength and chord modulus.

ISO 179-2:2020—Charpy impact strength (23° C., kJ/m² unless stated otherwise).

ISO 11357-1:2016—differential scanning calorimetry (DSC) for melting temperatures and crystallization temperatures of plastics.

Melting point (MP)—The endothermic peak which occurs during heating of small samples in a differential scanning calorimeter (DSC) (measured in accordance with ISO 11357-1:2016) Melt viscosity (MV)—An indicator of the melt flow characteristic of a resin as measured in Pascal seconds (Pa·sec) with a Kayness Capillary Rheometer measured at 280° C. under constant force conditions.

Molecular weight of polyamide resins is typically inferred by the measurement of solution viscosity. The two most common methods are: (i) ASTM D789-19 for relative viscosity (RV) measurement, and (ii) ISO 307:2019 using sulfuric acid to obtain viscosity number (VN) values. Viscosity values and trends to be considered are determined by the same method, regardless of which method is selected.

### Relative Viscosity (RV) of Resin

The polyamide can have any suitable RV (e.g., as measured in 8.4 wt. % solution in 90% formic acid), such as from 20 to 50 RV. The RV can be determined without the glass fibers mixed with the polyamide, wherein the polyamide is optionally free of any other materials that are in the glass fiber-filled polyamide composition (e.g., the substantially pure polyamide is measured for RV) or these materials are optionally included in the polyamide during the RV determination, such as if they affect RV. Other methods of determining the RV, such as a 1 wt. % solution in concentrated sulfuric acid, may be used and an appropriate correlation of RVs between the method used and the 8.4 wt. % in 90% Formic acid method, as used herein, can be determined. The RV measurements are typically performed at room temperature and atmospheric pressure.

Unless otherwise stated, the term “RV”, used in the Examples, refers to relative viscosity of a polymer sample as measured in an 8.4 wt. % solution in 90% formic acid at room temperature and atmospheric pressure in accordance with ASTM D789-19. The RV is the ratio of the viscosity of the solution to the viscosity of the solvent used. The solution is 8.4 wt. % polyamide solution in 90% formic acid. Formic acid is the solvent used.

### Amine End Groups (AEG)

Unless stated otherwise, AEG is determined by potentiometric titration of polymer dissolved in 68% Phenol/methanol mix, with 0.05M perchloric acid in propan-1-ol.

Unless stated otherwise, as used herein, room temperature is 25° C.

Unless stated otherwise, as used herein, atmospheric pressure is 1 bar.

### EXAMPLES

Various aspects of the present disclosure can be better understood by reference to the following Examples which are offered by way of illustration. The present disclosure is not limited to the Examples given herein.

In the below Examples, all are mass or weight ratios and weight percentages (wt. %) unless otherwise stated.

### Example 1

Into a 20 L temperature-controlled, jacketed glass vessel fitted with overhead stirrer and condenser and maintained under an atmosphere of nitrogen was added 7392 g demineralised water, 6800 g (25.92 mol) Nylon 66 salt, 243.5 g (2.095 mol) 2-methylpentamethylenediamine, 348.0 g (2.95 mol) isophthalic acid, 7.4 g (0.12 mol) acetic acid, and 47.0 g (0.24 mol) of a 60 wt % aqueous solution of hexamethylenediamine (1330 g, 11.44 mol). This produced a solution about 50 wt % in strength with a mole ratio of N66/DI of about 92.5/7.5 that also contained a 0.44 mol % addition of acetic acid (equivalent to about 19.3 mol per million gram [mpmg] on final polymer) on combined moles of adipic acid, and isophthalic acid, and a 0.86 mol % excess of amine groups from hexamethylenediamine (HMD) on combined moles of carboxylic acid groups from adipic acid, terephthalic acid and acetic acid. Excess hexamethylenediamine (HMD) was added to achieve the desired AEG target (in this example 65 mpmg) and also to compensate for evaporative losses during the polymerisation process.

This solution was added to a clean 24 L oil heated autoclave with an agitator, together with 0.51 g of a 50 wt % aqueous solution of Silwet L7605 antifoam agent (40 ppm active ingredient based on final polymer).

In the first cycle of the polymerisation process the solution was heated and vented when the pressure reached 170 psia and continued until the temperature had reached 198° C. In the second cycle venting was ceased and the pressure allowed to rise to 265 psia over 13 minutes by when the temperature of the contents had increased to about 216° C. In the third cycle venting was continued for 42 minutes whilst keeping the system at 265 psia until the temperature of the contents had reached 245° C. In the fourth cycle the pressure was reduced to atmospheric pressure over 33 minutes and the temperature of the contents had been increased to 271° C. In the fifth cycle vacuum was applied and the pressure reduced to 483 mbar over 6 minutes and held for 7 minutes, the vacuum was released with nitrogen over 1 minute and the temperature had reached 275° C. In the sixth cycle the polymer was extruded from the autoclave by a bottom extrusion valve using a maximum nitrogen pressure of 25 psia, onto a metal casting chute with cold water running down it, then the solidified polymer lace taken up a second chute with a counterflow of cold water and into a pelletisation unit.

The polymer had an RV of 33.8 and an AEG of 67.4 mpmg. RV was determined as per ASTM D789-19 8.4 w/w % in 90% formic acid and AEG was determined by potentiometric titration of polymer dissolved in 68% Phenol/methanol mix, with 0.05M perchloric acid in propan-1-ol.

### Examples 2-13

The polymers of Examples 2-13 were made in a similar manner to Example 1 and the measured data for RV and AEG for Examples 1-13 are tabulated in Table 1 below. In Table 1, the term “m % DI” represents mole % of DI in the formulation. The term “AcOH m %” represents mole % of acetic acid present in the final polymer. The term “AcOH mpmg” represents moles per million gram (mpmg) of acetic acid present in the final polymer. The term “Excess HMD (60%) (g)” represents the amount of 60 wt % aqueous HMD in grams. The terms “Excess HMD (m %)” and “Excess HMD mpmg” represent the excess HMD in mole % and moles per million gram (mpmg), respectively.

TABLE 1

| | | | | Excess | | | | |
|---|---|---|---|---|---|---|---|---|
| | | | | HMD | Excess | Excess | | |
| | m % | AcOH | AcOH | (60%) | HMD | HMD | | |
| Example | DI | m % | mpmg | (g) | (m %) | mpmg | RV | AEG |
| 1 | 7.5 | 0.44 | 19.3 | 47.0 | 1.07 | 132.7 | 33.76 | 67.4 |
| 2 | 7.5 | 0.44 | 19.3 | 7.1 | 0.13 | −14.0 | 29.73 | 41.79 |
| 3 | 7.5 | 0.44 | 19.3 | 32.1 | 0.59 | 58.2 | 40.13 | 50.62 |
| 4 | 5.6 | 0.43 | 19.1 | 32.1 | 0.59 | 58.8 | 40.60 | 48.69 |
| 5 | 3.7 | 0.43 | 19.1 | 32.1 | 0.59 | 58.9 | 35.06 | 57.80 |
| 6 | 3.7 | 0.43 | 19.1 | 45.0 | 0.83 | 96.3 | 32.19 | 64.52 |
| 7 | 7.5 | 0.44 | 19.3 | 58.0 | 1.07 | 132.7 | 25.25 | 88.68 |
| 8 | 7.5 | 0.44 | 19.3 | 47.0 | 1.07 | 132.7 | 39.07 | 59.83 |
| 9 | 7.5 | 0.44 | 19.3 | 47.0 | 1.07 | 132.7 | 44.15 | 58.78 |
| 10 | 3.7 | 0.43 | 19.1 | 46.9 | 0.86 | 101.5 | 37.84 | 63.75 |
| 11 | 7.5 | 0.78 | 34.2 | 56.3 | 1.03 | 100.9 | 23.34 | 84.23 |
| 12 | 5.6 | 0.43 | 19.1 | 46.9 | 0.86 | 101.3 | 34.04 | 65.41 |
| 13 | 9.4 | 0.44 | 19.3 | 47.0 | 0.86 | 100.8 | 36.92 | 67.58 |

In the examples of Table 1, the nylon-6,6 portion can be determined as m % nylon 66=100%-m % DI. Thus, the nylon-6,6 portion is 92.5 m % in Ex. 1-3, Ex. 7-9 and Ex. 11; 94.4 m % in Ex. 4 and Ex. 12; 96.3 m % in Ex. 5-6 and Ex. 10; and 90.6 m % for Ex. 13. Thus, Table 1 represents the Nylon 66:DI final product formulation range from 90:10 to 97:3 (mole:mole), and having RV range of from 22 to 45 and AEG range of from 40 to 90 milliequivalent per kg (meq/kg).

### Examples 14-20

In accordance with the present disclosure, Table 2 describes several variations of the nylon-6,6 copolymers that can be prepared in combination with the DI and D6 components. Examples 14-20 in Table 2 were made in a similar manner to Example 1. In these formulations, the term “DI Salt” represents an amide salt obtained from 2-methylpentamethylene diamine (MPMD, sold by INVISTA under the trademark Dytek® A amine) and isophthalic acid, known as 2-methylpentamethylene isophthalamide. The term “D6 Salt” represents an amide salt obtained from 2-methylpentamethylene diamine and adipic acid, known as 2-methylpentamethylene adipamide.

TABLE 2

| | Range | | | | | | | |
|---|---|---|---|---|---|---|---|---|
| | (mole | | Ex. 15 | Ex. 16 | | | | |
| Component | basis) | Ex. 14 | (reference) | (reference) | Ex. 17 | Ex. 18 | Ex. 19 | Ex. 20 |
| Nylon 66 | 65-99 | 92 | 70 | 82 | 90 | 97 | 96 | 94 |
| DI Salt | 1-20 | 8 | — | — | 10 | 3 | 4 | 6 |
| D6 Salt | 10-30 | — | 30 | 18 | — | — | — | — |
| End Capping | PPM (by | — | — | — | 900-2000 | | | |
| Agent [e.g.: | weight) | | | | | | | |
| Acetic Acid] | | | | | | | | |
| | TOTAL | 100 | 100 | 100 | 100 | 100 | 100 | 100 |
| Properties | | | | | | | | |
| RV | | 42-50 | 42-50 | 42-50 | 22-45 | 22-45 | 22-45 | 22-45 |
| AEG | meq/kg | 60-80 | 40-60 | 40-60 | 40-90 | 40-90 | 40-90 | 40-90 |
| Melting Temp | ° C. | 245-250 | 230-235 | 230-250 | 240-258 | 240-258 | 240-258 | 240-258 |
| Crystallization | ° C. | 175-195 | 150-170 | 175-195 | 160-210 | 160-210 | 160-210 | 160-210 |
| Temp | | | | | | | | |

Several nylon-6,6 formulations of Table 2 were compounded with glass fiber (GF) and the dimensional and mechanical properties were measured for these GF-reinforced specimens. The results are shown in Table 3. The GF reinforcement was in the range of 30 to 50 wt. % on the final polymer mass basis as shown in Table 3. For comparison, a high-AEG (60-90) Nylon 66 specimen reinforced with 30 wt % GF and a standard 48 RV and 50 AEG nylon 66 specimen reinforced with 50 wt % GF were also tested.

TABLE 3

| | | | | | High-AEG | 48RV |
|---|---|---|---|---|---|---|
| | Ex. 14 | Ex. 14 | Ex. 15 | Ex. 16 | Nylon 66 | Nylon 66 |
| | with 30 | with 50 | with 50 | with 50 | with 30 | with 50 |
| | wt % | wt % | wt % GF | wt % GF | wt % GF | wt % GF |
| | GF | GF | (reference) | (reference) | (reference) | (reference) |
| Gloss at 60° | 75 | 50 | n/a | n/a | 67 | 41 |
| angle | | | | | | |
| Shrinkage | n/a | 0.36% | 0.38% | 0.40% | n/a | 0.44% |
| (Parallel | | | | | | |
| direction) | | | | | | |
| Shrinkage | n/a | 0.83% | 0.81% | 0.97% | n/a | 1.06% |
| (Transverse | | | | | | |
| direction) | | | | | | |
| Tensile | 190 | 258 | 257 | 256 | 192 | 260 |
| Strength (MPa) | | | | | | |
| Tensile | 9.8 | 17.1 | 17.8 | 16.6 | 9.9 | 17.1 |
| Modulus (GPa) | | | | | | |
| Elongation at | 4.2 | 3.2 | 3.0 | 3.0 | 4.2 | 2.9 |
| Break, % | | | | | | |
| 23° C. Notched | 11.2 | 18 | 16 | 16 | 11.3 | 19 |
| Charpy (kJ/m²) | | | | | | |

### Examples 21-26

Examples 21-26 were prepared in accordance with the formulations provided in Table 4 and the fire resistance performance measured. Reference Examples 21 and 23 contain INVISTA HyperFlow™ U2501 PA66 Resin (which contains wt DI), whereas Examples 25 and 26 contain the copolymer of Example 14 (which is 92/8 n-66/1DJ (wt/wt)) and Examples 22 and 23 contain a combination of INVISTA HyperFlow™ U2501 PA66 Resin and the copolymer of Example 14.

TABLE 4
Fire Resistance Performance Data

| Component | Ex. 21 | | Ex. 23 | | | |
|---|---|---|---|---|---|---|
| (wt. %) | (reference) | Ex. 22 | (reference) | Ex. 24 | Ex. 25 | Ex. 26 |
| INVISTA U2501 | 50.5 | 25.25 | 83.5 | 41.75 | — | — |
| nylon-6,6 resin | | | | | | |
| Ex. 14 | — | 25.25 | | 41.75 | 58.8 | 61.8 |
| Copolymer | | | | | | |
| Glass Fiber [GF] | 40 | 40 | — | — | 20 | 20 |
| Heat Stabilizer | 0.9 | 0.9 | 1.5 | 1.5 | — | — |
| (e.g.: Cu-based | | | | | | |
| or organic based | | | | | | |
| such as | | | | | | |
| Irganox ® B1171) | | | | | | |
| Black MB | 0.6 | 0.6 | 1.0 | 1.0 | — | — |
| colorant (e.g.: | | | | | | |
| carbon black or | | | | | | |
| Nigrosine black | | | | | | |
| dye) | | | | | | |
| Flame Retardant | 8 | 8 | 14 | 14 | 20 | 17 |
| [FR] Additive | | | | | | |
| [e.g.: Exolit ® | | | | | | |
| 1080P, OP1400, | | | | | | |
| etc.] | | | | | | |
| Other additives | — | — | — | — | ≤2 | ≤2 |
| [UV, Light | | | | | | |
| Stabilizer,] | | | | | | |
| TOTAL | 100 | 100 | 100 | 100 | 100 | 100 |
| Thickness (mm) | 1.5 | 1.5 | 1.4 | 1.4 | 0.75, 1.5, 3.0 | |
| After-flame | 18 | <1 | 1-2 | <1 | <2 | ≤2 |
| Time (sec) | | | | | | |
| Weight Loss (%) | 0.12 | 0.05 | 0.1 | 0.1 | nm | nm |
| Flame Drip | No | No | No | No | No | No |

| | |
|---|---|
| UL-94 Vertical | V0 rating for all |
| Burn Rating | thicknesses |

nm—not measured

### Examples 27A-L

TABLE 5
Compounding using Twin-Screw Extruder

| | | | | | | | | Sp. | |
|---|---|---|---|---|---|---|---|---|---|
| | | | Glass | | | Die | Die | Energy | |
| | | | Fiber, | Screw | | Head | Head | Index, | Melt |
| Ex. | PA66/DI | | GF | Speed | % | Pressure | Temp | SEI | Cushion |
| ID. | wt/wt | RV | (wt. %) | (RPM) | Torque | (Bar) | (° C.) | (kwh/kg) | (mm) |
| 27A | 90/10 | 35 | 30 | 453 | 45 | 18 | 292 | 0.210 | 4.20 |
| 27B | | | 50 | 449 | 51 | 20 | 294 | 0.200 | 5.64 |
| 27C | 92/8 | 30 | 30 | 401 | 46 | 18 | 297 | 0.164 | 2.95 |
| 27D | | | 50 | 402 | 39 | 18 | 294 | 0.150 | 5.20 |
| 27E | | 35 | 30 | 446 | 44 | 18 | 288 | 0.206 | 3.64 |
| 27F | | | 50 | 390 | 51 | 20 | 291 | 0.189 | 4.73 |
| 27G | | 44 | 30 | 453 | 55 | 20 | 289 | 0.267 | 4.98 |
| 27H | | | 50 | 449 | 52 | 25 | 292 | 0.251 | 5.76 |
| 27I | 94/6 | 35 | 30 | 450 | 39 | 17 | 296 | 0.210 | 4.40 |
| 27J | | | 50 | 454 | 44 | 15 | 287 | 0.215 | 4.95 |
| 27K | 96/4 | 35 | 30 | 450 | 40 | 17 | 295 | 0.194 | 3.98 |
| 27L | | | 50 | 440 | 45 | 17 | 294 | 0.225 | 6.62 |

A twin-screw compounder used was 26-mm diameter co-rotating screw with a 48 L/D (i.e., L/D ratio of 48). In Table 5 compounding, the moisture level in the feedstock resins was less than 0.5 wt. The polymer feedstock and heat stabilizer [e.g.: Cu-based additive commercially available from Americhem] were pre-mixed in the 98.500 to 1.5% ratio (wt/wt). The glass fiber used was commercially obtained from Nippon Electric Glass [NEG]. All feeds were charged to the twin-screw compounder main hopper and the conditions were run as detailed in Table 5.

The mechanical properties of Examples 27A-L were then measured and the results are provided in Table 6.

TABLE 6
Mechanical Properties for Compounded Materials

| | Ex. ID. | | | | | | | | | | | |
|---|---|---|---|---|---|---|---|---|---|---|---|---|
| | 27A | 27B | 27C | 27D | 27E | 27F | 27G | 27H | 27I | 27J | 27K | 27L |
| Tensile | 186.92 | 242.16 | 196.59 | 261.03 | 189.37 | 254.41 | 183.44 | 238.08 | 189.31 | 252.71 | 191.2 | 251.8 |
| Strength | | | | | | | | | | | | |
| (Mpa) | | | | | | | | | | | | |
| Elongation @ | 3.93 | 3.43 | 3.50 | 3.39 | 3.69 | 3.52 | 4.30 | 3.52 | 3.56 | 3.51 | 3.9 | 3.6 |
| break (%) | | | | | | | | | | | | |
| Chord | 9.67 | 16.24 | 9.92 | 16.68 | 9.69 | 16.43 | 9.48 | 16.12 | 9.74 | 16.25 | 9.6 | 16.1 |
| Modulus | | | | | | | | | | | | |
| (GPa) | | | | | | | | | | | | |
| Notched | 10.62 | 17.46 | 11.35 | 19.58 | 11.28 | 17.08 | 11.59 | 16.32 | 10.92 | 17.94 | 11.3 | 17.3 |
| Charpy | | | | | | | | | | | | |
| (KJ/m²) | | | | | | | | | | | | |
| at RT | | | | | | | | | | | | |
| Notched | 9.19 | 15.86 | 10.78 | 19.52 | 10.05 | 16.23 | 10.18 | 15.07 | 10.13 | 16.66 | 10.6 | 15.7 |
| Charpy | | | | | | | | | | | | |
| (KJ/m²) | | | | | | | | | | | | |
| at −30° C. | | | | | | | | | | | | |
| Unnotched | 73.06 | 118.51 | 63.39 | 113.53 | 62.15 | 109.66 | 89.32 | 110.86 | 65.49 | 111.90 | 72.0 | 114.1 |
| Charpy | | | | | | | | | | | | |
| (KJ/m²) | | | | | | | | | | | | |
| at RT | | | | | | | | | | | | |
| Unnotched | 58.53 | 111.25 | 57.51 | 103.93 | 55.76 | 114.65 | 76.58 | 110.30 | 62.09 | 111.45 | 60.8 | 106.6 |
| Charpy | | | | | | | | | | | | |
| (KJ/m²) | | | | | | | | | | | | |
| at −30° C. | | | | | | | | | | | | |

All samples tested at Dry-as-molded [DAM]

### Examples 28A-H

In Table 7, Examples 28A-D were prepared in the absence of DI component (i.e., 0 wt. DI) in the total polyamide portion. On the other hand, Examples 28E-H were prepared with a 50:50 (wt:wt) blend of INVISTA HyperFlow™ U2501 PA66 Resin and Example 14 copolymer [which is 92/8 n-66/DI (wt/wt)]. The effective n-66/DI present in the total polyamide portion of Examples 28E-H was 96:4 (wt:wt). In both cases, the Flame Retardant [FR] Additive was varied from 0 wt. up to 14 wt. % in the total composition.

The improved UL-94 Vertical burn test performance ratings were observed for Example 28E-H test specimens over those for Example 28A-D specimens, especially, for 10 wt. % and 14 wt. % FR additive levels and for 3.0 mm thickness specimens.

TABLE 7
Formulations (all wt. %) and Mechanical Strength, FR Performance Data

| | Ex. ID. - | | | | | | | |
|---|---|---|---|---|---|---|---|---|
| | 28A | 28B | 28C | 28D | 28E | 28F | 28G | 28H |
| Component (wt. %) | | | | | | | | |
| INVISTA | 97.5 | 91.5 | 87.5 | 83.5 | 48.75 | 45.75 | 43.75 | 41.75 |
| HyperFlow ™ | | | | | | | | |
| U2501 PA66 | | | | | | | | |
| Resin | | | | | | | | |
| Example 14 | — | — | — | — | 48.75 | 45.75 | 43.75 | 41.75 |
| Copolymer | | | | | | | | |
| Heat Stabilizer | 1.5 | 1.5 | 1.5 | 1.5 | 1.5 | 1.5 | 1.5 | 1.5 |
| (e.g .: Cu-based or | | | | | | | | |
| organic based | | | | | | | | |
| such as Irganox ® | | | | | | | | |
| B1171) | | | | | | | | |
| Black MB | 1 | 1 | 1 | 1 | 1 | 1 | 1 | 1 |
| Colorant (e.g .: | | | | | | | | |
| carbon black or | | | | | | | | |
| Nigrosine black | | | | | | | | |
| dye) | | | | | | | | |
| Flame Retardant | — | 6 | 10 | 14 | — | 6 | 10 | 14 |
| [FR] Additive | | | | | | | | |
| [e.g.: Exolit ® | | | | | | | | |
| 1080P, OP1400, | | | | | | | | |
| etc.] | | | | | | | | |
| TOTAL - | 100 | 100 | 100 | 100 | 100 | 100 | 100 | 100 |
| Effective n-66/DI | 100/0 | | | | 96/4 | | | |
| (wt/wt) in total | | | | | | | | |
| polyamide - | | | | | | | | |
| Mechanical | | | | | | | | |
| Strength Data | | | | | | | | |
| Yield Stress | NV | 59.3 | 75.2 | 69.2 | 88.5 | 80.6 | 75.3 | 66.5 |
| (MPa) | | | | | | | | |
| Tensile strength | 84.1 | 49.7 | 75.2 | 69.2 | 88.5 | 80.6 | 75.3 | 66.5 |
| (MPa) | | | | | | | | |
| Elongation @ | 4.1 | 2.1 | 4.9 | 4.7 | 14.8 | 10.8 | 8.5 | 4.2 |
| break (%) | | | | | | | | |
| Chord Modulus | 3.17 | 3.35 | 3.38 | 3.45 | 3.09 | 3.24 | 3.33 | 3.44 |
| (GPa) (0.3% to | | | | | | | | |
| 0.5% Strain) | | | | | | | | |
| Notched Charpy | 4.29 | 3.5 | 3.24 | 2.8 | 3.95 | 3.65 | 3.44 | 3.32 |
| (KJ/m²) (0.5 J | | | | | | | | |
| Hammer) at | | | | | | | | |
| Room Temp | | | | | | | | |
| Un-Notched | 53.1 | 57 | 57.6 | 42.4 | 73.7 | 113.3 | 63.3 | 47.9 |
| Charpy (KJ/m²) | | | | | | | | |
| (7.5 J Hammer) at | | | | | | | | |
| Room Temp | | | | | | | | |
| FR Performance | | | | | | | | |
| Data - 0.4 mm | | | | | | | | |
| thickness sample | | | | | | | | |
| 24 h at 23° C. | V-2 | V-2 | V-2 | V-2 | V-2 | V-2 | V-2 | V-2 |
| sample | | | | | | | | |
| conditioning [RT | | | | | | | | |
| Conditioned] | | | | | | | | |
| FR Performance | | | | | | | | |
| UL-94 V Rating | | | | | | | | |
| Classification | | | | | | | | |
| 168 h at 70° C. | V-2 | V-2 | V-2 | V-2 | V-2 | V-2 | V-2 | V-2 |
| sample | | | | | | | | |
| conditioning | | | | | | | | |
| [Heat-aged] | | | | | | | | |
| FR Performance | | | | | | | | |
| UL-94 V Rating | | | | | | | | |
| Classification | | | | | | | | |
| FR Performance | | | | | | | | |
| Data - 0.75 mm | | | | | | | | |
| thickness sample | | | | | | | | |
| 24 h at 23° C. | V-2 | V-2 | V-2 | V-2 | V-2 | V-2 | NR | V-0 |
| sample | | | | | | | | |
| conditioning [RT | | | | | | | | |
| Conditioned] | | | | | | | | |
| FR Performance | | | | | | | | |
| UL-94 V Rating | | | | | | | | |
| Classification | | | | | | | | |
| 168 h at 70° C. | V-2 | V-2 | V-2 | V-1 | V-2 | V-2 | NR | V-2 |
| sample | | | | | | | | |
| conditioning | | | | | | | | |
| [Heat-aged] | | | | | | | | |
| FR Performance | | | | | | | | |
| UL-94 V Rating | | | | | | | | |
| Classification | | | | | | | | |
| FR Performance | | | | | | | | |
| Data - 1.5 mm | | | | | | | | |
| thickness sample | | | | | | | | |
| 24 h at 23° C. | V-2 | V-2 | NR | V-0 | V-2 | V-2 | NR | V-0 |
| sample | | | | | | | | |
| conditioning [RT | | | | | | | | |
| Conditioned] | | | | | | | | |
| FR Performance | | | | | | | | |
| UL-94 V Rating | | | | | | | | |
| Classification | | | | | | | | |
| 168 h at 70° C. | V-2 | V-2 | NR | V-1 | V-2 | V-2 | NR | V-1 |
| sample | | | | | | | | |
| conditioning | | | | | | | | |
| [Heat-aged] | | | | | | | | |
| FR Performance | | | | | | | | |
| UL-94 V Rating | | | | | | | | |
| Classification | | | | | | | | |
| FR Performance | | | | | | | | |
| Data - 3 mm | | | | | | | | |
| thickness | | | | | | | | |
| 24 h at 23° C. | V-2 | V-2 | V-1 | V-0 | V-2 | V-2 | V-0 | V-0 |
| sample | | | | | | | | |
| conditioning [RT | | | | | | | | |
| Conditioned] | | | | | | | | |
| FR Performance | | | | | | | | |
| UL-94 V Rating | | | | | | | | |
| Classification | | | | | | | | |
| 168 h at 70° C. | V-2 | V-2 | V-1 | V-0 | V-2 | V-2 | V-0 | V-0 |
| sample | | | | | | | | |
| conditioning | | | | | | | | |
| [Heat-aged] | | | | | | | | |
| FR Performance | | | | | | | | |
| UL-94 V Rating | | | | | | | | |
| Classification | | | | | | | | |

“NR”—No rating from the test.

As can be seen from the data in Table 7, Examples 28E and 28F have improved mechanical strength compared with Examples 28A-D. Indeed, Examples 28E and 28F have improved tensile properties despite having less flame-retardant additive than Examples 28C and 28D thereby demonstrating one of the advantages of the present invention, specifically that the presence of 96/4 (wt/wt) n-66/1DJ materials enables less FR additive to be used.

Compared to control n-66 with 0 wt % DI, superior FR rating [UL-94 rating of V-0] was observed for 3 mm thick specimens of 96/4 (wt/wt) n-66/1DI materials at both RT and heat-aged conditions, and for FR levels ≥10 wt %. The FR performance was similar for 0.4 mm, 0.75 mm and 1.5 mm thick specimens.

### Aspects of the Disclosure

Aspects of the disclosure include the following:
1) A composition of matter comprising:
   a) random copolymer of:
      i) a first straight-chain aliphatic condensation polyamide; and
      ii) a second condensation polyamide comprising a branched diamine and an aromatic diacid, wherein the mass ratio of first straight-chain aliphatic condensation polyamide to second condensation polyamide is from ≥85:15 to ≤99:1; and
   b) from ≥5 wt % to ≤25 wt % of non-halogenated flame retardant additive; wherein the FR performance, as measured by flammability measurement according to the Underwriters Laboratories standard [UL 94] for Vertical Burn test, of the composition exceeds the FR performance of a control consisting essentially of nylon-6,6 characterized by formic acid RV within ±3 and AEG ±5, both in comparison to the random copolymer (a).
2) The composition of aspect 1 wherein composition contains from ≥50% to ≤80% of the halogen-free phosphorus-containing FR additive as the control.
3) The composition of aspect 1 wherein the first straight-chain aliphatic condensation polyamide comprises at least one of PA 46, PA 66; PA 69; PA 610, PA 612, PA 1012, PA 1212, PA 66/6T, PA 6I/6T, PA 66/6I/6T or blends, such as PA6/PA66, polyhexamethylene decanamide (N610), polyhexamethylene dodecanamide (N612), polyhexamethylene succinamide (N46), polyhexamethylene azelamide (N69), polydecamethylene sebacamide (N1010), polydodecamethylene dodecanamide (N1212), nylon 6 (N6), nylon 11 (N11), polylaurolactam (N12).
4) The composition of aspect 1 wherein the branched diamine is a C4 to C12 diamine.
5) The composition of aspect 1 wherein the branched diamine is at least one of 1,3-pentanediamine, 2-ethyl-butanediamine, 2-methylpentamethylene diamine, 3-methylpentamethylene diamine, 2-methylhexamethylene diamine, 3-methylhexamethylene diamine, 2,5-dimethylhexamethylene diamine, 2,2,4-trimethylhexamethylene diamine, 2,4,4-trimethylhexamethylene diamine, 2,7-dimethyloctamethylene diamine and 2,2,7,7-tetramethyloctamethylene diamine.
6) The composition of aspect 1 wherein the aromatic diacid is a C5 to C12 diacid containing from ≥1 to ≤3 aromatic rings per monomer unit.
7) The composition of aspect 6 wherein the aromatic diacid comprises at least one diacid of the formula HO—C(O)—R1-C(O)—OH, wherein the variable R1 is substituted or unsubstituted furan, benzofuranyl, phenyl, naphthyl, anthracenyl.
8) The composition of aspect 7, wherein the aromatic diacid comprises terephthalic acid and isophthalic acid.
9) The composition of any one preceding aspect wherein the non-halogenated flame retardant additive is at least one selected from the group consisting of phosphorus based FR additives consisting of:
   a) organophosphorus based acids such as diarylphosphinic or diarylphosphonic or dialkylphosphinic or dialkylphosphonic acids, and their salts (including metal salts and organic salts);
   b) dihydrooxaphosphaphenanthrene (DOPO) and its derivatives;
   c) polyphosphazenes;
   d) organo-nitrogen based FR additives including melamine and its salts;
   e) boron based FR additives including metal borates; and
   f) silicon based FR additives such as silicones.
10) The composition of aspect 9 wherein the non-halogenated flame retardant additive is selected from melamine cyanurate, aluminium diethylphosphinate, melamine polyphosphate, antimony trioxide, dehydrated zinc borate and combinations thereof.
11) Disclosed is a composition of matter comprising:
   a) a random copolymer of:
      (1) a first aliphatic condensation polyamide containing less than 0.1 wt. % of monomers selected from branched diamines and aromatic diacids;
      (2) a second condensation polyamide comprising a branched diamine and an aromatic diacid; and
   b) a halogen-free phosphorus-containing flame retardant additive.
12) The composition of aspect 11 wherein:
   a) the weight ratio of the first aliphatic condensation polyamide a)(1) to the second condensation polyamide a)(2) is from ≥90:10 to ≤94:6; and
   b) the flame-resist performance of the random copolymer as measured by the Underwriters Laboratories standard [UL 94] Vertical Burn test exceeds the performance (as measured by the same UL 94 Vertical Burn test) of a control comprising:
      (1) the first aliphatic condensation polyamide of a)(1);
      (2) from ≥0 to ≤0.1 wt. % of the second condensation polyamide of a)(2); and
      (3) the same (±0.5% based on weight of additive) amount of halogen-free phosphorus-containing flame retardant additive, wherein said first aliphatic condensation polyamide of a)(2) and the random copolymer of a) are both characterized by the same formic acid RV within ±3 and the same AEG within ±5.
13) The composition of aspect 12 wherein composition and the control both further comprise from ≥5 wt. % to ≤25 wt. % of halogen-free phosphorus-containing flame retardant additive.
14) The composition of any aspect 12 or 13 wherein the composition contains from ≥50% to ≤80% of the halogen-free phosphorus-containing FR additive compared to the control.
15) The composition of any one of aspect 12 to 14 wherein the first straight-chain aliphatic condensation polyamide comprises an aliphatic diamine.
16) The composition of aspect 15 wherein the branched diamine is a C4 to C12 diamine characterized by carbon branching ratio selected from the group consisting of:
   a) ≥0 to ≤1;
   b) ≥0.2 to ≤0.8; and
   c) ≥0.25 to ≤0.75;
wherein the carbon branching ratio is defined as the extent to which aliphatic carbons are present in branches versus in the backbone chain of the molecular.
17) The composition of aspect 16 wherein the branched diamine is at least one of 1,3-pentanediamine, 2-ethyl-butanediamine and 2-methylpentamethylene diamine.
18) The composition of aspect 16 wherein the aromatic diacid is a C5 to C12 diacid containing from ≥1 to ≤3 aromatic rings per monomer unit.
19) The composition of aspect 18 wherein the aromatic diacid comprises at least one of the composition of claim 6 wherein the aromatic diacid comprises at least one diacid of the formula HO—C(O)—R1-C(O)—OH, wherein the variable R1 is substituted or unsubstituted furan, benzofuranyl, phenyl, naphthyl, anthracenyl.
20) The composition of aspect 19, wherein the aromatic diacid comprises terephthalic acid and isophthalic acid.
21) The composition of any one of aspects 11-20 wherein the non-halogenated flame retardant additive is at least one selected from the group consisting of phosphorus based FR additives consisting of:
   a) organophosphorus based acids such as diarylphosphinic or diarylphosphonic or dialkylphosphinic or dialkylphosphonic acids, and their salts (including metal salts and organic salts);
   b) dihydrooxaphosphaphenanthrene (DOPO) and its derivatives;
   c) polyphosphazenes;
   d) organo-nitrogen based FR additives including melamine and its salts;
   e) boron based FR additives including metal borates; and
   f) silicon based FR additives such as silicones.
22) The composition of aspect 21 wherein the halogen-free phosphorus-containing flame retardant additive is selected from melamine cyanurate, aluminium diethylphosphinate, melamine polyphosphate, antimony trioxide, dehydrated zinc borate and combinations thereof.
23) Composition of matter comprising:
   a) random copolymer of n-6,6/DI having weight ratio of n-6,6 to (D+II of from ≥85:15 to ≤99:1; and
   b) from ≥5 wt. % to ≤25 wt. % of halogen-free phosphorus-containing flame retardant additive;
      i) wherein the performance of the composition comprising (a) and (b) as measured by UL 94 Vertical Burn testing exceeds the performance (as measured by the same UL 94 Vertical Burn testing) of a control comprising:
         1. nylon-6,6 containing ≤0.1 wt. % of (D+I), said nylon-6,6 characterized by formic acid RV within ±3 and within AEG±5, both compared to the random copolymer (a) both in comparison to the random copolymer (a); and
         2. from ≥5 wt. % to ≤25 wt. % of halogen-free phosphorus-containing flame retardant additive.
24) The composition of aspect 23 wherein composition comprising (a) and (b) contains from ≥50% to ≤80% of the halogen-free phosphorus-containing flame retardant additive as the control.
25) The composition of aspect 23 or aspect 24 wherein the flame retardant additive is at least one selected from the group consisting of melamine cyanurate, aluminium diethylphosphinate, melamine polyphosphate, antimony trioxide, dehydrated zinc borate and combinations thereof.

1-31. (canceled)

32. A composition of matter comprising:
a) random copolymer of:
i) a first straight-chain aliphatic condensation polyamide; and
ii) a second condensation polyamide comprising a branched diamine and an aromatic diacid, wherein the mass ratio of the first straight-chain aliphatic condensation polyamide to the second condensation polyamide is from ≥85:15 to ≤99:1; and
b) from ≥5 wt % to ≤25 wt % of non-halogenated flame retardant additive;
wherein the flame-retardancy (FR) performance, as measured by flammability measurement according to the Underwriters Laboratories standard (UL 94) for Vertical Burn test, of the composition exceeds the FR performance of a control consisting essentially of nylon-6,6 characterized by formic acid relative viscosity (RV) within ±3 and amine end groups (AEG) within ±5 of the random copolymer (a), and
wherein the composition of matter contains from ≥50% to ≤80% of the non-halogenated flame retardant (FR) additive compared to the control.

33. The composition of claim 32, wherein the first straight-chain aliphatic condensation polyamide contains less than 0.1 wt. % of monomers selected from branched diamines and aromatic diacids.

34. The composition of claim 32, wherein the first aliphatic condensation polyamide is a straight-chain aliphatic condensation polyamide comprising an aliphatic diamine.

35. The composition of claim 32, wherein the composition and the control both comprise from ≥5 wt. % to ≤25 wt. % of the halogen-free phosphorus-containing flame retardant additive.

36. The composition of claim 32, wherein the non-halogenated flame retardant additive is a non-halogenated phosphorus-containing flame retardant additive.

37. The composition of claim 32, wherein the non-halogenated flame retardant (FR) additive is a non-halogenated phosphorus-containing flame retardant (FR) additive and the composition contains from ≥50% to ≤80% of the non-halogenated phosphorus-containing flame retardant (FR) additive compared to the control.

38. The composition of claim 32, wherein the first straight-chain aliphatic condensation polyamide comprises PA 46, PA 66, PA 69, PA 610, PA 612, PA 1012, PA 1212, PA 66/6T, PA 6I/6T, PA 66/6I/6T, PA6/PA66, polyhexamethylene decanamide (N610), polyhexamethylene dodecanamide (N612), polyhexamethylene succinamide (N46), polyhexamethylene azelamide (N69), polydecamethylene sebacamide (N1010), polydodecamethylene dodecanamide (N1212), nylon 6 (N6), nylon 11 (N11), polylaurolactam (N12), or a combination thereof.

39. The composition of claim 32, wherein the branched diamine is a C₄ to C₁₂ diamine.

40. The composition of claim 32, wherein the branched diamine is at least one of 1,3-pentanediamine, 2-ethyl-butanediamine, 2-methylpentamethylene diamine, 3-methylpentamethylene diamine, 2-methylhexamethylene diamine, 3-methylhexamethylene diamine, 2,5-dimethylhexamethylene diamine, 2,2,4-trimethylhexamethylene diamine, 2,4,4-trimethylhexamethylene diamine, 2,7-dimethyloctamethylene diamine, and 2,2,7,7-tetramethyloctamethylene diamine.

41. The composition of claim 32, wherein the aromatic diacid is a C₅ to C₁₂ diacid containing from ≥1 to ≤3 aromatic rings per monomer unit.

42. The composition of claim 32, wherein the aromatic diacid comprises at least one diacid of the formula HO—C(O)—R¹—C(O)—OH, wherein the variable R¹ is substituted or unsubstituted furan, benzofuranyl, phenyl, naphthyl, or anthracenyl.

43. The composition of claim 32, wherein the aromatic diacid comprises terephthalic acid and/or isophthalic acid.

44. The composition of claim 32, wherein the random copolymer is n-6,6/DI having a weight ratio of n-6,6 to (D+I) of from ≥85:15 to ≤99:1.

45. The composition of claim 32, wherein the non-halogenated flame retardant additive is at least one selected from the group consisting of:
a) an organophosphorus based acid;
b) dihydrooxaphosphaphenanthrene (DOPO) or its derivatives;
c) a polyphosphazene;
d) an organo-nitrogen based FR additive;
e) a boron-based FR additive; and
f) a silicon-based FR additive.

46. The composition of claim 32, wherein the non-halogenated flame retardant additive is selected from melamine cyanurate, aluminium diethylphosphinate, melamine polyphosphate, antimony trioxide, dehydrated zinc borate, and combinations thereof.

47. The composition of claim 32, wherein the halogen-free phosphorus-containing flame retardant additive is selected from aluminium diethylphosphinate, melamine polyphosphate, and combinations thereof.

48. A composition of matter comprising:
a) a random copolymer of:
(1) a first aliphatic condensation polyamide containing less than 0.1 wt. % of monomers selected from branched diamines and aromatic diacids;
(2) a second condensation polyamide comprising a branched diamine and an aromatic diacid; and
b) a halogen-free phosphorus-containing flame retardant (FR) additive,
wherein:
i) the weight ratio of the first aliphatic condensation polyamide a)(1) to the second condensation polyamide a)(2) is from ≥90:10 to ≤94:6; and
ii) the flame-retardancy performance of the random copolymer as measured by the Underwriters Laboratories standard (UL 94) Vertical Burn test exceeds the performance (as measured by the same UL 94 Vertical Burn test) of a control comprising:
(1) the first aliphatic condensation polyamide of a)(1);
(2) from ≥0 to ≤0.1 wt. % of the second condensation polyamide of a)(2); and (3) the same (i.e., ±0.5% based on weight of additive) amount of halogen-free phosphorus-containing flame retardant additive, wherein said first aliphatic condensation polyamide of ii)(1) and the random copolymer of a) are both characterized by the same formic acid relative viscosity (RV) (i.e., within ±3 of each other) and the same amine end groups AEG (i.e., within ±5 of each other), and
wherein the composition of matter contains from ≥50% to ≤80% of the halogen-free phosphorus-containing FR additive compared to the control.

49. A composition of matter comprising:
a) random copolymer of n-6,6/DI having weight ratio of n-6,6 to (D+I) of from ≥85:15 to ≤99:1; and
b) from ≥5 wt. % to ≤25 wt. % of halogen-free phosphorus-containing flame retardant additive;
i) wherein the performance of the composition comprising (a) and (b) as measured by UL 94 Vertical Burn testing exceeds the performance (as measured by the same UL 94 Vertical Burn testing) of a control comprising:
1. nylon-6,6 containing ≤0.1 wt. % of (D+I), said nylon-6,6 characterized by formic acid RV within ±3 and AEG with ±5 of the random copolymer (a); and
2. from ≥5 wt. % to ≤25 wt. % of halogen-free phosphorus-containing flame retardant additive, and
wherein the composition of matter comprising (a) and (b) contains from ≥50% to ≤80% of the halogen-free phosphorus-containing flame retardant additive compared to the control.

50. A method of forming the composition of matter of claim 32, the method comprising:
combining the random copolymer and the non-halogenated flame retardant additive, to form the composition of matter;
wherein the flame-retardancy (FR) performance, as measured by flammability measurement according to the Underwriters Laboratories standard (UL 94) for Vertical Burn test, of the composition exceeds the FR performance of a control consisting essentially of nylon-6,6 characterized by formic acid relative viscosity (RV) within ±3 and amine end groups (AEG) within ±5 of the random copolymer (a), and
wherein the composition of matter contains from ≥50% to ≤80% of the non-halogenated flame retardant (FR) additive compared to the control.

51. The method of claim 50, wherein the branched diamine is obtained from one or more C₄-C₁₂ branched dinitrile(s) that are recovered from a manufacturing process, converted to corresponding C₄-C₁₂ branched diamine, and incorporated into the random copolymer as an alternative to burning the branched dinitrile as fuel
